(19) United States
(12) Patent Application Publication
(10) Pub. No.: US 2026/0346939 A1
(43) Pub. Date: Nov. 5, 2026

(54) HUMAN-MACHINE INTERFACE PLATFORM

(71) Applicant: Also, Inc., Palo Alto, CA (US)

(72) Inventors: Arth Nireshkumar PATEL, San Jose, CA (US); Patrick HARRINGTON, Asheville, NC (US); Jonathan Louis HALL, Menlo Park, CA (US); Christopher YU, Menlo Park, CA (US)

(73) Assignee: Also, Inc., Palo Alto, CA (US)

(21) Appl. No.: 19/197,274

(22) Filed: May 2, 2025

(51) Int. Cl. B62J 50/22; B62J 3/10; B62K 23/02; B62M 6/80; B62M 11/00; G06F 3/0362

(52) U.S. Cl. CPC B62J 50/22; B62J 3/10; B62K 23/02; B62M 6/80; B62M 11/00; G06F 3/0362

(57) ABSTRACT

A system can include a display assembly, a control assembly, and an accessory assembly. The display assembly can couple with a handlebar of a bicycle. The display assembly can receive one or more first inputs to indicate a mode for the bicycle. The control assembly can couple with a first handle of the handlebar. The control assembly can receive one or more second inputs to indicate one or more actions of the bicycle. The accessory assembly can couple with a second handle of the handlebar. The accessory assembly can receive one or more third inputs to cause at least one adjustment to the one or more actions of the bicycle.

### INTRODUCTION

Bicycles can include one or more portions.

### SUMMARY

This disclosure is generally related to one or more components of a bicycle. The components can include at least one of assemblies, sub-assemblies, modules, systems, platforms, or components. For example, the bicycle can include a system which includes one or more assemblies or sub-assemblies. The assemblies can include at least one of a display assembly, a control assembly, or an accessory assembly. The assemblies can be located, placed, positioned, secured, mounted, coupled, or otherwise disposed on or within one or more portions of the bicycle. For example, the display assembly can be coupled with a center or middle portion of a handlebar. As another example, the control assembly can be coupled with a handle of the handlebar.

At least one aspect is directed to a system. The system can include a display assembly. The display assembly can couple with a handlebar of a bicycle. The display assembly can present one or more sets of information associated with one or more aspects of the bicycle. The display assembly can receive one or more first inputs to indicate a mode for the bicycle. The system can include a control assembly. The control assembly can couple with a first handle of the handlebar. The control assembly can receive one or more second inputs. The one or more second inputs can, based on the mode for the bicycle, indicate an amount of propulsion for the bicycle or a mechanical gear for the bicycle. The system can include an accessory assembly. The accessory assembly can couple with a second handle of the handlebar. The accessory assembly can receive one or more third inputs. The one or more third inputs can indicate an adjustment to an audible output produced by a speaker of the bicycle, cause the one or more second inputs to switch from an indication of the amount of propulsion to an indication of the mechanical gear for the bicycle, or cause the one or more second inputs to switch from the indication of the mechanical gear for the bicycle to the indication of the amount of propulsion.

At least one aspect is directed to a bicycle. The bicycle can include a handlebar. The handlebar can include a first handle and a second handle. The bicycle can include a display assembly. The display assembly can couple with the handlebar. The display assembly can receive one or more inputs. The one or more inputs can be to present one or more sets of information associated with one or more aspects of the bicycle or indicate a mode for the bicycle. The bicycle can include a control assembly. The control assembly can couple with the first handle. The control assembly can receive one or more second inputs. The one or more second inputs can indicate an amount of propulsion for the bicycle or a mechanical gear for the bicycle. The bicycle can include an accessory assembly. The accessory assembly can couple with the second handle. The accessory assembly can receive one or more third inputs. The one or more third inputs can indicate an adjustment to an audible output produced by a speaker of the bicycle, cause the one or more second inputs to switch from an indication of the amount of propulsion to an indication of the mechanical gear for the bicycle, or cause the one or more second inputs to switch from the indication of the mechanical gear for the bicycle to the indication of the amount of propulsion.

At least one aspect is directed to an assembly such as a Human-Machine Interface platform. The Human-Machine Interface platform can include a display assembly. The display assembly can couple with a handlebar of a bicycle. The display assembly can receive one or more first inputs to indicate a mode for the bicycle. The Human-Machine Interface platform can include a control assembly. The control assembly can couple with a first handle of the handlebar. The control assembly can receive one or more second inputs to indicate one or more actions of the bicycle. The Human-Machine Interface platform can include an accessory assembly. The accessory assembly can couple with a second handle of the handlebar. The accessory assembly can receive one or more third inputs to cause at least one adjustment to the one or more actions of the bicycle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example bicycle, in accordance with some aspects.

FIG. 2 depicts the example bicycle of FIG. 1, in accordance with some aspects.

FIG. 3 depicts a perspective view of a handlebar included in the bicycle of FIG. 2, in accordance with some aspects.

FIG. 4 depicts a perspective view of a handle included in the handlebar of FIG. 3, in accordance with some aspects.

FIG. 5 depicts a perspective view of a handle included in the handlebar of FIG. 3, in accordance with some aspects.

FIG. 6 depicts a perspective view of a display assembly included in a system for the bicycle of FIG. 2, in accordance with some aspects.

FIG. 7 depicts a perspective view of a display assembly included in a system for the bicycle of FIG. 2, in accordance with some aspects.

FIG. 8 depicts a perspective view of a display assembly included in a system for the bicycle of FIG. 2, in accordance with some aspects.

FIG. 9 depicts a perspective view of a display assembly included in a system for the bicycle of FIG. 2, in accordance with some aspects.

FIG. 10 depicts a perspective view of a display assembly included in a system for the bicycle of FIG. 2, in accordance with some aspects.

FIG. 11 depicts a perspective view of a display assembly included in a system for the bicycle of FIG. 2, in accordance with some aspects.

FIG. 12 depicts a perspective view of a display assembly included in a system for the bicycle of FIG. 2, in accordance with some aspects.

FIG. 13 depicts a perspective view of a display assembly included in a system for the bicycle of FIG. 2, in accordance with some aspects.

FIG. 14 is a flow diagram of a process for a Human-Machine Interface platform, in accordance with some aspects.

FIG. 15 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of one or more assemblies for a bicycle. The various concepts introduced above and discussed in greater detail below may be implemented in any of numerous ways.

The present disclosure is directed to one or more components for a bicycle. The components can include one or more assemblies, systems, modules, elements, or components. For example, the bicycle can include a display assembly which includes a selector element and a display device. The bicycle can include a system which includes an accessory assembly. The system or assemblies thereof can include one or more devices or components. For example, the system can include at least one input device (e.g., toggles, buttons, levers, switches, knobs, paddles, capacitive touch devices, cursors, selectable elements, etc.) that can receive one or more inputs. The inputs can represent or indicate one or more of requests, control inputs, operational parameters, or interactions. For example, a selection of a button, included in the system, can represent a selection of a mode for the bicycle. The button can be associated with controlling which mode the bicycle operates in. In this example, a press of the button (e.g., an input) can indicate the mode for the bicycle.

Bicycles or other possible rideable vehicles can include input devices, such as rotary knobs (or other selectable elements), buttons, toggles, or levers, however these input devices are often predefined (e.g., not reconfigurable, not modifiable, etc.). Stated otherwise, the offerings or actions associated with selection of a given input device cannot be defined or modified by an operator of the bicycle. Moreover, utilization of these input devices (while operating or otherwise driving the bicycle) is restricted as some actions can be disabled or otherwise disengaged while the bicycle is moving.

Restricted utilization of these input devices can result in a frustrated operator experience, as several features or offerings of the bicycle may be unavailable while driving or otherwise maneuvering the bicycle. For example, while a bicycle is in motion, an operator of the bicycle can be prevented from switching a mode of operation for the bicycle. This prevention can result in the operator having to stop or otherwise halt movement of the bicycle in order to switch the mode of operation.

The disclosed solutions have a technical advantage of providing one or more assemblies having input devices which remain active and modifiable while a bicycle is being operated. For example, the bicycle can include an accessory assembly which includes one or more input devices to control operation of the bicycle. The input devices can include knobs, dials, buttons, toggles, levers, among other possible devices. Moreover, one or more interactions (e.g., inputs, requests, feedback, etc.) with the input devices can be interpretated differently based on the interaction. For example, holding (e.g., an interaction) a button can be interpreted as providing a first input. As another example, double tapping (e.g., an interaction) the button can be interpreted as providing a second input, which is different than the first input. The first input and the second input can result in the bicycle taking one or more discrete or different actions. For example, a processor can, responsive to detection of the first input or the second input, cause the bicycle to switch from operating in a first mode to operating in a second mode.

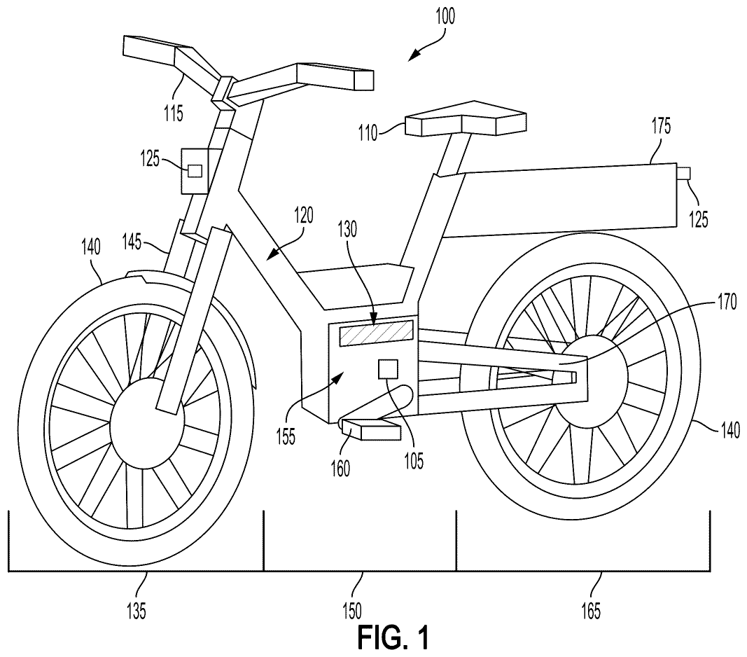

FIG. 1 depicts an example perspective view of a bike 100. The bike 100 can be an electric bike installed with at least one battery pack 105. The bike 100 can include at least one bicycle. The bike 100 can be a human-operated bike. The bike 100 can include single rider bicycles, tandem bicycles, cargo bicycles, motor-assist bicycles, pedicabs, electric-assist bicycles, road bicycles, mountain bicycles, or unicycles, among others. The battery pack 105 can also be used as an energy storage system to power a building, such as a residential home or commercial building. The bike 100 can be fully electric or partially electric (e.g., pedal-powered) and further, the bike 100 can be fully autonomous, partially autonomous, semi-autonomous, or unmanned. The bike 100 can also be human operated or non-autonomous.

A human operator or rider of the bike 100 can sit on a seat 110 to operate the bike 100. The rider of the bike 100 can steer, grip, balance, or otherwise control the bike 100 using handlebar 115. The rider or operator of the bike 100, for which the seat 110 can support, can refer to or include a primary occupant of the bike 100.

The bike 100 can include a frame 120. The frame 120 can support various components of the bike 100, such as the handlebar 115, the seat 110, the battery pack 105, at least one light 125, and at least one lock assembly 130. The frame 120 can span a front portion 135. The front portion 135 can support, be coupled with, or include, for example, a wheel 140 of the bike 100, a fork 145 of the bike 100, the handlebar 115, the light 125, among other components. The bike 100 can include two or more wheels 140 (e.g., a front wheel 140 and a rear wheel 140).

The frame 120 can span a middle portion 150. The middle portion 150 can support, be coupled with, or include, for example, the seat 110, the battery pack 105, a crank shaft or drive mechanism 155 of the bike 100, or a pedal 160 of the bike 100, among other components. The frame 120 can include the middle portion 150 including the lock assembly 130. The frame 120 can include a rear portion 165. The rear portion 165 can support, be coupled with, or include, for example, a rear wheel 140 of the bike 100, the light 125, a drive train 170 of the bike 100, a rack assembly 175 of the bike 100, or among other components. The battery pack 105 can be disposed anywhere within the frame 120.

The battery pack 105 can include at least one battery, at least one battery module, or at least one battery cell. The battery pack 105 can be electrically coupled with the bike 100 (e.g., to the drive mechanism 155, to the light 125, the lock assembly 130, or some other components). For example, the battery pack 105 can provide electrical energy to the bike 100 to power the bike 100.

The battery pack 105 can be installed or placed within the bike 100. For example, the battery pack 105 can be installed on the frame 120 of the bike 100 within one or more of the front portion 135, the middle portion 150, or the rear portion 165. The battery pack 105 can be integrally coupled with the frame 120 such that it is not removable. The battery pack 105 can be detachably coupled with the frame 120 such that in can be removed (e.g., to charge the battery pack 105).

The battery pack 105 can include or connect with at least one busbar, e.g., a current collector element. For example, the busbar can include electrically conductive material to connect or otherwise electrically couple the battery pack 105 with other electrical components of the bike 100 to provide electrical power to various systems or components of the bike 100, such as the lock assembly 130 or some other system.

The bike 100 can include the lock assembly 130 electrically coupled with the battery pack 105. For example, the battery pack 105 can be electrically coupled with a receiver of the lock assembly 130 to facilitate the actuation or movement of one or more components of the receiver. In this way, the receiver can be configured to be controlled or actuated electronically via power provided by the battery pack 105, rather than being controlled or actuated manually or mechanically (e.g., via some manual action of an operator). The battery pack 105 can provide power to other components of the bike 100 (e.g., the drive mechanism 155, the light 125, or some other component) simultaneously, separately, in sequence, or in some other manner.

The bike 100 can be electrically propelled or manual propelled. For example, the bike 100 can include a series hybrid propulsion system. As another example, the battery pack 105 can provide power to the drive mechanism 155 to power the drive train 170 to propel the bike 100 (e.g., propel the bike by causing the at least one wheel 140 to rotate). As another example, an operator of the bike 100 can operate or otherwise move the pedals 160 to manual move or power the drive train 170.

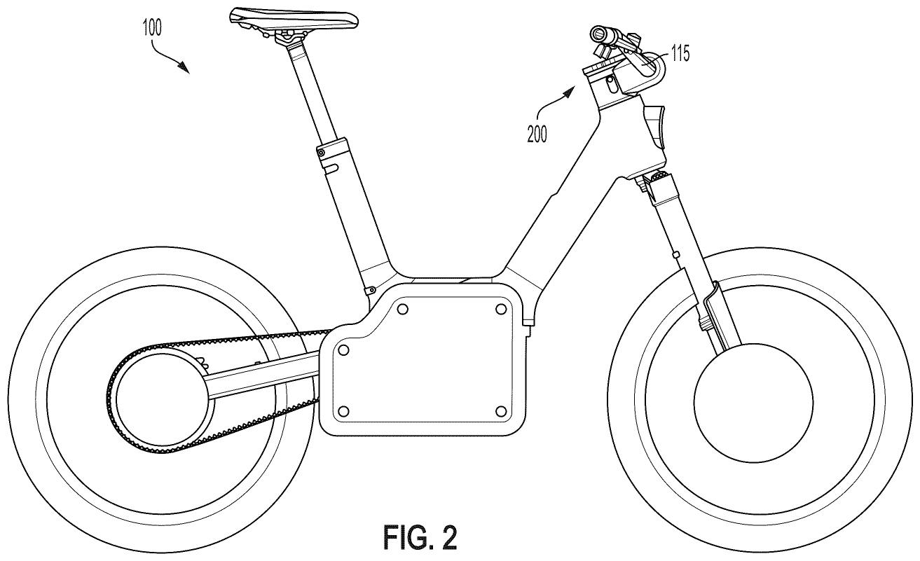

FIG. 2 depicts the bike 100, in accordance with some aspects. The view of the bike 100, as shown in FIG. 2, can refer to or include a side-view. The bike 100 or one or more components thereof can include sub-components, elements, or members. For example, as shown in FIG. 2, the bike 100 includes an assembly 200. The assembly 200 can include at least one assembly or component as described herein. For example, the assembly 200 can include one or more selector elements. As another example, the assembly 200 can include a display assembly. The assembly 200 can refer to or include at least one of a system, a platform, or an integrated package. For example, the assembly 200 can include at least one system which represents or includes one or more assemblies. As another example, the assembly 200 can include at least one Human-Machine Interface platform.

The assembly 200 can be located at or disposed on one or more portions or areas of the bike 100. For example, as shown in FIG. 2, the assembly 200 is disposed on or otherwise coupled with the handlebar 115. As another example, the assembly 200 can be disposed on the frame 120. The assembly 200 can be coupled with one or more components of the bike 100. For example, the assembly 200 can be electrically coupled with the battery pack 105 such that the assembly 200 can receive electrical energy from the battery pack 105. As another example, the assembly 200 can be communicably coupled with the drive train 170 such that the assembly 200 can send signals to or receive signals from the drive train 170. As another example, the assembly 200 can be communicably coupled with a computing device or processing circuitry which controls operation of the bike 100.

The assembly 200 can be integrated with the handlebar 115 such that at least a portion or segment of the assembly 200 is unified with the handlebar 115. Stated otherwise, a housing or other possible assembly (which defines the handlebar 115) can include at least a portion of the assembly 200 (e.g., the assembly 200 is included in or disposed within a housing of the handlebar 115).

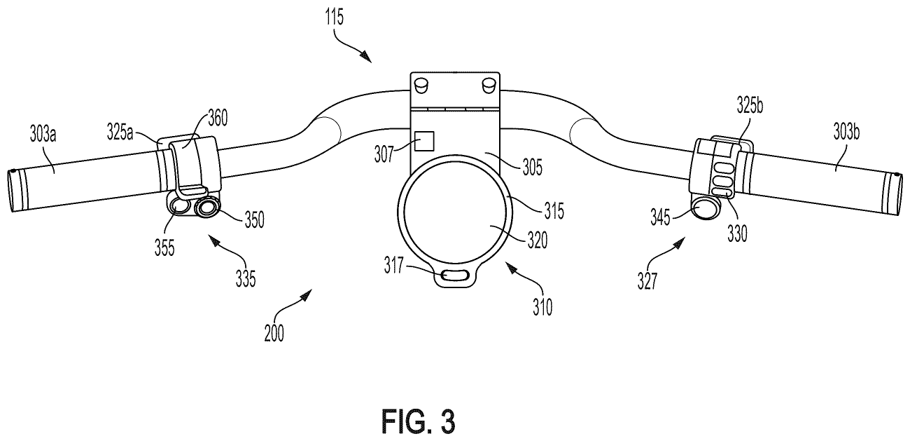

FIG. 3 depicts a perspective view of the handlebar 115, in accordance with some aspects. The handlebar 115 can facilitate or otherwise control one or more operations of the bike 100. For example, the handlebar 115 can twist, rotate, or otherwise move to cause the bike 100 to maneuver or otherwise travel in a given direction. Stated otherwise, operation of the handlebar 115 can cause the bike 100 to turn to the left or turn to the right. Additionally, the handlebar 115 can provide support to an operator of the bike 100. For example, an operator of the bike 100 can grasp or otherwise hold the handlebar 115 to provide support to the operator of the bike 100.

The handlebar 115 can include at least one of segments, portions, components, sections, or parts. For example, the handlebar 115 can include at least one handle 303. FIG. 3 depicts an example of the handlebar 115 including a first handle 303a (shown as a left handle) and a second handle 303b (shown as a right handle). An operator of the bike 100 can grasp or otherwise interface with the handles 303. For example, the handles 303 can include a soft or cushioned surface for which an operator of the bike 100 can rest or otherwise place their hands.

The handlebar 115 can include at least one paddle 325. For example, as shown in FIG. 3, the handlebar 115 includes a first paddle 325a and a second paddle 325b. The paddles 325 can operate or perform similar to at least one of hand brakes, gear shifters, a horn, a directional, among other possible operations.

The handlebar 115 can include or otherwise house at least a portion of the assembly 200. For example, the assembly 200 can couple with a central portion of the handlebar 115. As another example, the assembly 220 can be located proximate to at least of the first handle 303a or the second handle 303b. The assembly 200 can include one or more components, sub-components, assemblies, sub-assemblies, or other possible modules. For example, as shown in FIG. 3, the assembly 200 includes a housing 305. The housing 305 can define or establish at least one of a shape, area, dimension, or proportions of the assembly 200 or one or more components thereof. For example, the housing 305 can define an appearance or overall size of a module, sub-assembly, or device of the assembly 200. The housing 305 can include one or more recesses, voids, cavities, openings, or apertures to receive one or more components of the assembly 200.

The assembly 200 can include at least one of a display assembly 310, a control assembly 327, or an accessory assembly 335. The assemblies or components (e.g., the display assembly 310, the control assembly 327, the accessory assembly 335, etc.) can be discrete or separate from one another. For example, the display assembly 310 can be located at a first location of the handlebar 115 which is discrete from a second location for which the control assembly 327 is located. As another example, the control assembly 327 can be located proximate to the second handle 303b and the accessory assembly 335 can be located proximate to the first handle 303a.

The housing 305 can receive the display assembly 310. For example, the display assembly 310 can be inserted into or otherwise placed within an opening of the housing 305. As another example, the display assembly 310 can be coupled with or otherwise secured to the housing 305. The display assembly 310 can include at least one selector element 315 and at least one display device 320. The selector element 315 can receive at least one input. For example, the selector element 315 can receive an input to indicate a mode of the bike 100. The mode or modes of the bike 100 can include the bike 100 providing an amount of propulsion (e.g., activation of the drive mechanism 155 to move or power the drive train 170) or operating in accordance to one or more mechanical gears (e.g., rotation or movement of the pedals 160 results in the drive train 170 moving the bike 100).

The selector element 315 can move, pivot, rotate, or otherwise spin to receive one or more inputs. For example, the selector element 315 can receive a first input responsive to the selector element 315 having rotated by a given amount (e.g., an angle, an angular rotation, etc.). Stated otherwise, the amount for which the selector element 315 is rotated or otherwise moved can result in receipt of one or more inputs. As another example, the selector element 315 can move about an axis to receive one or more inputs.

The selector element 315 can adjust the bike 100 between a locked state (e.g., a first mode) to a powered state (e.g., a second mode). For example, the selector element 315 can rotate by 90 degrees (or other possible angular amounts) to switch the bike 100 from the locked stated to the powered state. The selector element 315 can change one or more operations of the bike 100 responsive to adjusting the modes of the bike 100. For example, the selector element 315 can dictate when electrical energy is provided, by the battery pack 105, to the drive train 170. As another example, the selector element 315 can dictate whether the lock assembly 130 is activated or deactivated.

The selector element 315 can include at least one mode indicator 317. The mode indicator 317 can present or otherwise indicate a mode of the bike 100. For example, the mode indicator 317 can include one or more light sources (e.g., light emitting diodes, halogen lights, illuminating elements, etc.) which can emit light or color to indicate a mode of the bike 100. The mode indictor 317 can emit a first color or light pattern to indicate a first mode of the bike 100. As another example, the mode indicator 317 can emit a second color or light pattern to indicate a second mode of the bike 100.

The display device 320 can include at least one of a screen, a monitor, a graphical device, or other possible devices which can present information or one or more sets of information. For example, the display device 320 can include a liquid crystal display (LCD) screen that can present or otherwise provide graphical information (e.g., images, pictures, graphical illustrations, digital information, etc.). The display device 320 can present information associated with one or more aspects of the bike 100. For example, the display device 320 can present a graphical element or a graphical user interface which indicates a speed of the bike 100. As another example, the display device 320 can present a graphical element which indicates a state of charge of one or more batteries of the battery pack 105. As another example, the display device 320 can present a graphical element which provides navigation information to an operator of the bike 100.

The display device 320 can receive one or more inputs. For example, the display device 320 can, responsive to interactions or selections of icons displayed by the display device 320, receive one or more inputs regarding a mode of the bike 100. Stated otherwise, the display device 320 can receive one or more inputs with adjust or change a presentment of information. The change in the presentment of information can include an operator of the bike 100 scrolling or otherwise transitioning between pages or views on the display device 320. For example, the change in the presentment of information can include updating, modifying, replacing, or adjusting which information (that corresponds to the bike 100) is presented by the display device 320.

The display device 320 can receive one or more inputs which indicate a mode for the bike 100. For example, the display device 320 can, responsive to selection of an icon which corresponds to a mode of the bike 100, receive an input which indicates the mode for the bike 100. As another example, scrolling between pages or views of a graphical user interface, displayed by the display device 320, can provide one or more inputs which indicate a mode. Stated otherwise, a first page can be associated with a first mode and a second page can be associated with a second mode. Selection or navigation to the first page or the second page can indicate a corresponding mode for the bike 100.

The control assembly 327 can include at least one input device to receive inputs associated with controlling the drive mechanism 155 of the drive train 170. For example, as shown in FIG. 3, the control assembly 327 includes a shifter 330 (shown as a twist or rotatable shifter) and a throttle 345. The shifter 330 can receive one or more inputs (e.g., twists, rotations, interactions, operations, etc.) to indicate one or more controls for the bike 100. For example, a rotation (e.g., an input) of the shifter 330 can indicate a respective gear for the drive train 170. As another example, the shifter 330 can indicate an amount of assist for which the drive mechanism 155 operates the drive train 170.

The throttle 345 can receive one or more inputs (e.g., depressions, rotations, actuations, presses, etc.) which cause the drive mechanism 155 to power the drive train 170. For example, one or more inputs, received by the throttle 345, can cause the drive mechanism 155 to power the drive train 170 regardless of whether an operator the bike 100 is spinning, rotating, or otherwise using the pedals 160.

The inputs, received by the control assembly 327, can be based on one or more modes of the bike 100. For example, while the bike 100 is operating in an assist mode (e.g., the drive mechanism 155 is providing power to the drive train 170 to assist an operator in powering or otherwise moving the bike 100), one or more inputs received by the shifter 330 can indicate an amount of propulsion. Stated otherwise, if the bike 100 is operating in an assist mode, one or more inputs (received by the control assembly 327) can indicate how much assistance to provide. As another example, if the bike 100 is operating in a manual mode, a mechanical mode, or a transmission mode, one or more inputs received by the shifter 330 can indicate a mechanical gear for the drive train 170.

The accessory assembly 335 can include one or more input devices. For example, as shown in FIG. 3, the accessory assembly 335 includes a dial 350, a button 355, and a lever 360. The input devices of the accessory assembly 335 (e.g., the dial 350, the button 355, the lever 360, etc.) can receive one or more inputs. For example, the button 355 can actuate (e.g., pressed, compressed, selected, held, touched, etc.) to receive inputs. As another example, the dial 350 can be spin or rotate in a first direction to receive a first input. The inputs, received by the accessory assembly 335, can indicate one or more requests, modifications, controls, or actions for the bike 100. For example, the bike 100 can include a speaker and an input (received by the dial 350) can indicate an audible output (e.g., decibel level, volume, etc.). As another example, a single press of the dial 350 can provide a play/pause feature. Stated otherwise, a first press of the dial 350 can pause an audible output, a second press of the dial 350 can resume the audible output, or vice versa.

The button 355 can receive one or more inputs to adjust or modify interpretations or indications associated with inputs provided to the control assembly 327. For example, if the bike 100 is operating in an assist mode (e.g., the drive mechanism 155 provides power to the drive train 170), selection or compression of the button 355 can result in inputs (received by the shifter 330) to switch from an indication of an amount of propulsion to an indication of a mechanical gear. Stated otherwise, the input (e.g., selection, compression, etc.) received by the button 355 can result in the bike 100 switching operating modes. As another example, if the bike 100 is operating in a manual mode, compression/selection of the button 355 can cause inputs (received by the shifter 330) to switch from an indication of a mechanical gear to an indication of an amount of propulsion.

The button 355 can provide modularity or reconfigurability of the control assembly 327 as engagement or disengagement of the button 355 can alter, switch, change, or otherwise modify how inputs (received by the control assembly 327) can be interpretated. For example, the operator of the bike 100 can switch the bike 100 from operating in an assist mode to operating in a manual mode by compressing the button 355 and providing one or more inputs to the control assembly 327. Stated otherwise, the mode of the bike 100 can switch via activation of the button 355 and one or more subsequent inputs to the control assembly 327.

The bike 100 or one or more components thereof can include at least one processing circuit 307. For example, processing circuit 307 can be included in a system which also includes the control assembly 327. As another example, the processing circuit 307 can be included in a control mechanism which drives operations of the bike 100. The processing circuit 307 can refer to or include at least one processor, coupled with memory. For example, the processor can execute one or more instructions (stored by the memory), which cause the processing circuit 307 to perform at least one action, process, or step described herein.

The processing circuit 307 can be communicably coupled with one or more components of the bike 100. For example, the processing circuit 307 can communicate with the battery pack 105 to control a discharge of power by the battery pack 105. As another example, the processing circuit 307 can provide, generate, or otherwise transmit one or more signals, which cause the drive mechanism 155 to activate or deactivate. The processing circuit 307 can detect one or more inputs. For example, inputs received by the shifter 330, responsive to rotation or activation of the shifter 330, are detectable by the processing circuit 307. Stated otherwise, the processing circuit 307 can detect one or more inputs provided to or received by the assembly 200 or one or more components thereof.

The processing circuit 307 can implement or otherwise execute one or more control actions based on detected inputs. For example, the processing circuit 307 can adjust (e.g., increase, decrease, modify, change, etc.) an amount of propulsion by transmitting signals to the drive mechanism 155. The signals provided to the drive mechanism 155 can result in an adjustment or modification of an output (e.g., mechanical power, torque, etc.) produced by the drive mechanism 155 and provided to the drive train 170. For example, if the input (received by the shifter 330) indicates a request for 50% output of the drive mechanism 155, the processing circuit 307 can transmit, responsive to detection of the input, control signals which cause the drive mechanism 155 to operate at 50% capacity or output. As another example, if the input (received by the shifter 330) indicates a respective mechanical gear for the drive train 170, the processing circuit 307 can transmit one or more control signals which cause the drive train 170 to operate in accordance with the respective mechanical gear.

The accessory assembly 335 (or one or more input devices thereof) can move about an axis. For example, the dial 350 can rotate about an axis. The rotation of the dial 350 can cause the dial 350 to receive one or more inputs. For example, the dial 350 can receive an input to indicate an adjustment to an audible output. The audible output can be produced by a speaker of the bike 100. For example, the speaker can play music, provide audible feedback (e.g., a beep, a chime, a dine, a ping, etc.), or replicate a sound of a horn.

The adjustment to the audible output can include at least one of an adjustment to a decibel level for the audible output, a pause of the audible output, a continuation of the audible output, an interrupt of the audible output, or a selection of the audible output. For example, the dial 350 can move about an axis (rotate clockwise, rotate counterclockwise, etc.) to receive an input to indicate an adjustment to the decibel level. Stated otherwise, the volume of the audible output can increase or decrease based on the direction for which the dial 350 moves. As another example, the dial 350 can actuate (e.g., pressed, selected, compressed, etc.) to receive an input to indicate at least one of a pause of the audible output, a continuation of the audible output, an interrupt to the audible output, or a selection of the audible output.

The processing circuit 307 can interpret the inputs, provided to the accessory assembly 335, based on a status or current operation of the accessory assembly 335 or the audible output. For example, if the speaker is currently producing an audible output, the processing circuit 307 can interrupt an actuation of the dial 350 as an indication to pause or stop the audible output. As another example, if the audible output was previously stop, the processing circuit 307 can interrupt the actuation of the dial 350 as an indication to resume or start the audible output. As another example, the processing circuit 307 can interrupt a double press of the dial 350 (e.g., two or more actuations, selections, etc.) which are in close succession to one another (e.g., within 5 milliseconds, within 2 milliseconds, etc.) as an indication to skip or otherwise interrupt a song (e.g., audible output).

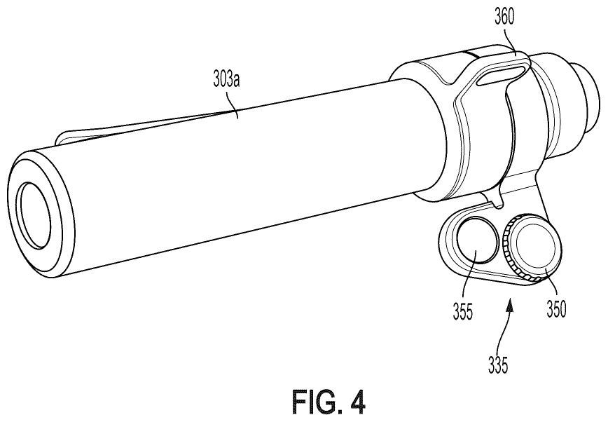

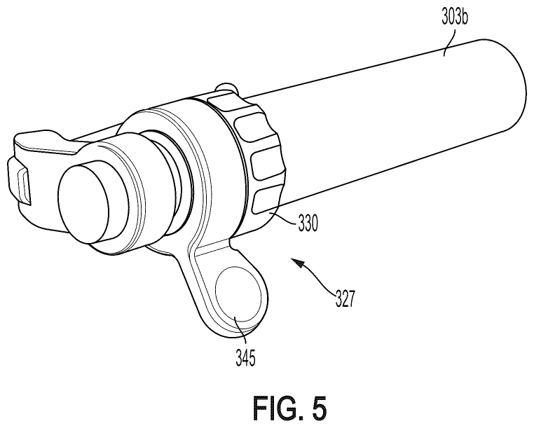

FIGS. 4-5 depict perspective views of the handles 303, in accordance with some aspects. The assembly 200 or one or more components thereof can be located proximate to or otherwise positioned near the handles 303. For example, as shown in FIG. 4, the accessory assembly 335 is positioned or located proximate to the first handle 303a. The accessory assembly 335 can be located, relative to the first handle 303a, in space such that the accessory assembly 335 is within reach of at least one finger or digit of an operator the bike 100 while the operator maintains control or grip of the first handle 303a. Stated otherwise, the accessory assembly 335 is reachable without the operator having to let go or otherwise ungrasp the first handle 303a.

As another example, as shown in FIG. 5, the control assembly 327 is positioned or located proximate to the second handle 303b. The control assembly 327 can be positioned or otherwise located in space and with respect to or relative to the second handle 303b such that the control assembly 327 is within reach of at least one finger or digit of the operator of the bike 100. Stated otherwise, while a hand of the operator is grasping, holding, gripping, or otherwise resting on the second handle 303b, the control assembly 327 is within reach of the operator.

The button 355 can actuate to receive at least one input. For example, the button 355 can, responsive to selection (e.g., actuate, actuation, etc.), receive an input to cause one or more inputs (received by the control assembly 327) to switch from an indication of an amount of propulsion to an indication of a mechanical gear. Stated otherwise, the processing circuit 307 can interpret one or more inputs (received by the control assembly 327) based on inputs received by the button 355.

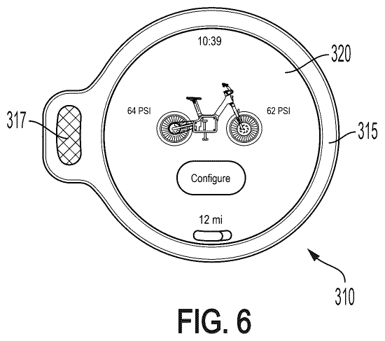

FIGS. 6-13 depict perspective views of the display assembly 310, in accordance with some aspects. The display assembly 310 can present or otherwise provide at least one graphical element. For example, as shown in FIG. 6, the display device 320 can present a graphical user interface which includes a graphical depiction of a bike (e.g., the bike 100). The display device 320 can receive one or more inputs via the graphical user interface. For example, a selection of a given icon, within the graphical user interface, can cause the display device 320 to receive an input.

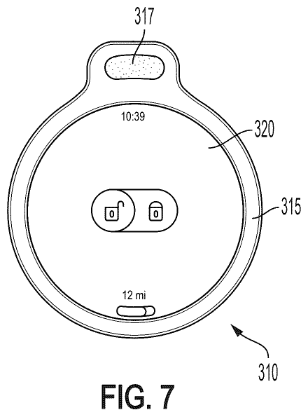

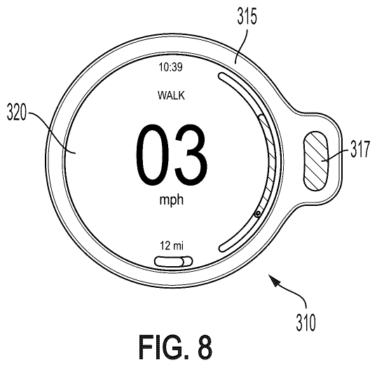

The display assembly 310 can receive one or more inputs to adjust a state or status of the bike 100. For example, as shown in FIG. 7, the display assembly 310 can present a graphical user interface to receive an input to lock or unlock the bike 100. As another example, as shown in FIG. 8, the display assembly can present a graphical user interface to receive an input to adjust a mode (e.g., switch from an assist mode to a transmission mode) of the bike 100.

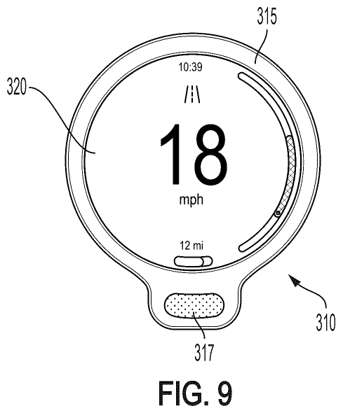

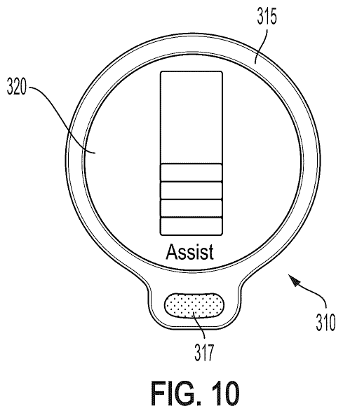

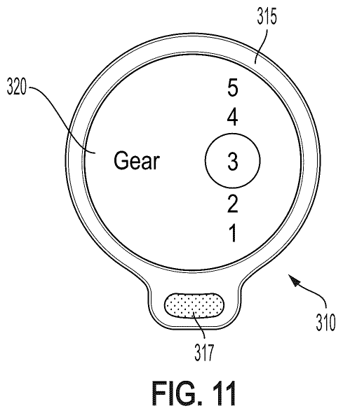

The display assembly 310 can present information associated with one or more aspects of the bike 100. For example, as shown in FIG. 9, the display device 320 can present a graphical user interface that illustrates a current speed of the bike 100. As another example, as shown in FIG. 10, the display device 320 can present a graphical user interface that indicates an amount of assist that is being provided by the drive mechanism 155. As even another example, as shown in FIG. 11, the display device 320 can present a graphical user interface that indicates a current mechanical gear for the drive train 170.

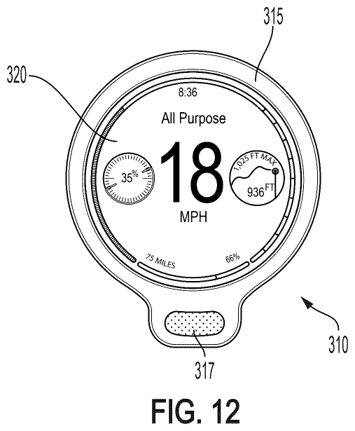

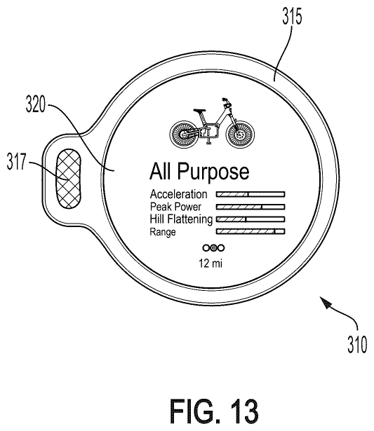

The display assembly 310 can present information associated with a trip or ride using the bike 100. For example, as shown in FIG. 12, the display device 320 can present a graphical user interface which identifies a total altitude associated with a ride. The graphical user interface can include information about a status of one or more batteries. For example, as shown in FIG. 12, the display device can present a graphical user interface which identifies a State of Charge for one or more batteries. As another example, as shown in FIG. 13, the display device 320 can present a graphical user interface which includes information associated with one or more outputs of the bike 100, such as acceleration, power, range, among other information.

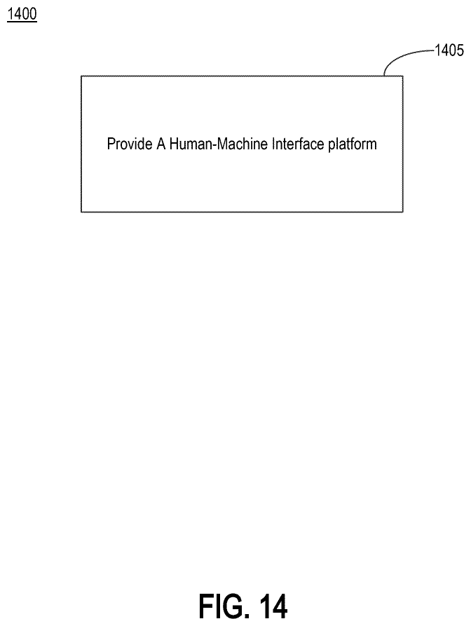

FIG. 14 is a flow diagram of a process 1400, in accordance with some aspects. The process 1400 can include manufacturing, providing, packaging, or otherwise making available at least one component described herein. For example, the process 1400 can include the packaging of the assembly 200. As another example, the process 1400 can include assembling the control assembly 327.

At act 1405, a Human-Machine Interface platform can be provided. For example, a Human-Machine Interface platform that includes the control assembly 327 can be provided. The Human-Machine Interface platform can be provided by at least one of coupling, securing, attaching, or otherwise mounting the Human-Machine Interface platform to a bike. For example, the Human-Machine Interface platform can be coupled with the bike 100 during the manufacturing or assembling of the bike 100. As another example, the Human-Machine Interface platform can be retrofitted to bike 100. Stated otherwise, the Human-Machine Interface platform can be provided as an add-on to the bike 100.

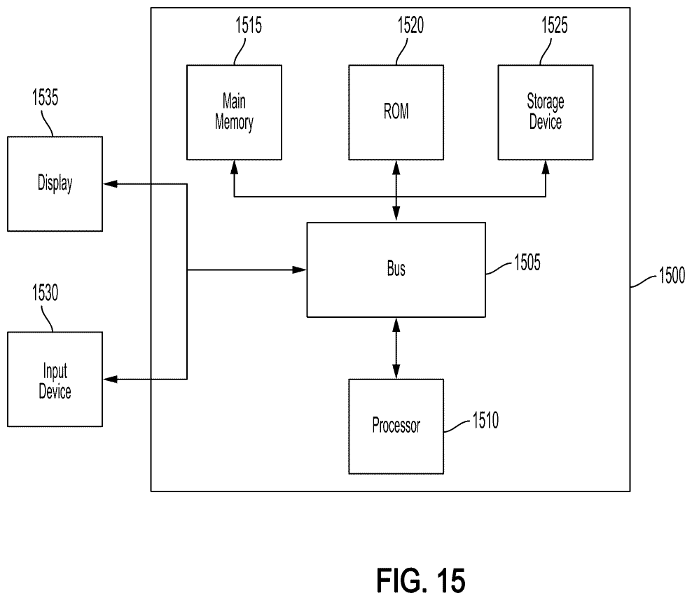

FIG. 15 is a block diagram illustrating an architecture for a computer system 1500 that can be employed to implement elements of the systems, methods, and assemblies described and illustrated herein. For example, the computer system 1500 can be included in or housed in the display assembly 310. The computing system 1500 can include at least one bus 1505 or other communication component for communicating information and at least one processor 1510 or processing circuit coupled to the bus 1505 for processing information. The computing system 1500 can also include one or more processors 1510 or processing circuits coupled to the bus for processing information. The computing system 1500 also includes at least one main memory 1515, such as a random access memory (RAM) or other dynamic storage device, coupled to the bus 1505 for storing information, and instructions to be executed by the processor 1510. The main memory 1515 can be used for storing information during execution of instructions by the processor 1510. The computing system 1500 may further include at least one read only memory (ROM) 1520 or other static storage device coupled to the bus 1505 for storing static information and instructions for the processor 1510. A storage device 1525, such as a solid state device, magnetic disk or optical disk, can be coupled to the bus 1505 to persistently store information and instructions.

The computing system 1500 may be coupled via the bus 1505 to a display 1535, such as a liquid crystal display, or active matrix display, for displaying information to a user such as a rider of the bike 100 or other end user. An input device 1530, such as a keyboard or voice interface may be coupled to the bus 1505 for communicating information and commands to the processor 1510. The input device 1530 can include a touch screen display 1535. The input device 1530 can also include a cursor control, such as a mouse, a trackball, or cursor direction keys, for communicating direction information and command selections to the processor 1510 and for controlling cursor movement on the display 1535.

The processes, systems and methods described herein can be implemented by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. Hard-wired circuitry can be used in place of or in combination with software instructions together with the systems and methods described herein. Systems and methods described herein are not limited to any specific combination of hardware circuitry and software.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical, or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A system, comprising:
a display assembly to couple with a handlebar of a bicycle, the display assembly configured to:
present one or more sets of information associated with one or more aspects of the bicycle; and
receive one or more first inputs to indicate a mode for the bicycle;
a control assembly to couple with a first handle of the handlebar, the control assembly configured to:
receive one or more second inputs to, based on the mode for the bicycle, indicate:
an amount of propulsion for the bicycle; or
a mechanical gear for the bicycle; and
an accessory assembly to couple with a second handle of the handlebar, the accessory assembly configured to:
receive one or more third inputs to indicate an adjustment to an audible output produced by a speaker of the bicycle, wherein the one or more third inputs include a plurality of inputs, wherein the adjustment to the audible output produced by the speaker of the bicycle includes a first adjustment and a second adjustment, and wherein the accessory assembly further includes an input device configured to:
move about an axis to receive a first input of the plurality of inputs, the first input to indicate the first adjustment; and
actuate to receive a second input of the plurality of inputs, the second input to indicate the second adjustment.

2. The system of claim 1, comprising:
one or more processors, coupled with memory, in communication with the control assembly; and
the one or more processors configured to:
detect the one or more second inputs; and
provide, responsive to detection of the one or more second inputs, one or more signals, to a drive mechanism of the bicycle that is configured to power a drive train of the bicycle, to cause the drive train to provide the amount of propulsion for the bicycle.

3. The system of claim 1, wherein the mode for the bicycle corresponds to a drive train of the bicycle to operate in accordance with the mechanical gear for the bicycle, and further comprising:
one or more processors, coupled with memory, in communication with the control assembly and the drive train; and
the one or more processors configured to:
detect the one or more second inputs; and
provide, responsive to detection of the one or more second inputs, one or more signals to cause the drive train to operate in accordance with the mechanical gear for the bicycle.

4. The system of claim 1, wherein the mode for the bicycle includes at least one of:
an assist mode which includes operation of a drive mechanism of the bicycle to power a drive train of the bicycle; or
a transmission mode which includes operation of the drive train in accordance with the mechanical gear for the bicycle or one or more second mechanical gears for the bicycle.

5. (canceled)

6. The system of claim 1, comprising:
the input device configured to:
actuate to receive at least one third input of the plurality of inputs, the at least one third input to:
cause the one or more second inputs to switch from an indication of the amount of propulsion to an indication of the mechanical gear; or
cause the one or more second inputs to switch from the indication of the mechanical gear to the indication of the amount of propulsion.

7. The system of claim 1, wherein the adjustment to the audible output produced by the speaker of the bicycle includes at least one of:
an adjustment to a decibel level for the audible output;
a pause of the audible output;
a continuation of the audible output;
an interrupt to the audible output; or
a selection of the audible output from a plurality of audible outputs.

8. The system of claim 1, wherein the display assembly further includes:
a display device configured to:
present, via a graphical user interface, the one or more sets of information associated with the one or more aspects of the bicycle; and
receive, via the graphical user interface, one or more fourth inputs to adjust presentment of the one or more sets of information associated with the one or more aspects of the bicycle; and
a selector element configured to move about a second axis to receive the one or more first inputs.

9. A bicycle, comprising:
a handlebar including a first handle and a second handle;
a display assembly to couple with the handlebar, the display assembly configured to:
receive one or more first inputs to:
present one or more sets of information associated with one or more aspects of the bicycle; or
indicate a mode for the bicycle;
a control assembly to couple with the first handle, the control assembly configured to:
receive one or more second inputs to indicate:
an amount of propulsion for the bicycle; or
a mechanical gear for the bicycle; and
an accessory assembly to couple with the second handle, the accessory assembly configured to receive one or more third inputs, wherein the one or more third inputs include a plurality of inputs, and wherein the accessory assembly further includes:
an input device configured to actuate to receive at least one input of the plurality of inputs, the at least one input to:
cause the one or more second inputs to switch from an indication of the amount of propulsion to an indication of the mechanical gear for the bicycle; or
cause the one or more second inputs to switch from the indication of the mechanical gear for the bicycle to the indication of the amount of propulsion.

10. The bicycle of claim 9, comprising:
one or more processors, coupled with memory, in communication with the control assembly; and
the one or more processors configured to:
detect the one or more second inputs; and
provide, responsive to detection of the one or more second inputs, one or more signals, to a drive mechanism of the bicycle that is configured to power a drive train of the bicycle, to cause the drive train to provide the amount of propulsion for the bicycle.

11. The bicycle of claim 9, wherein the mode for the bicycle corresponds to a drive train of the bicycle to operate in accordance with the mechanical gear for the bicycle, and further comprising:
one or more processors, coupled with memory, in communication with the control assembly and the drive train; and
the one or more processors configured to:
detect the one or more second inputs; and
provide, responsive to detection of the one or more second inputs, one or more signals to cause the drive train to operate in accordance with the mechanical gear for the bicycle.

12. The bicycle of claim 9, wherein the mode for the bicycle includes at least one of:
an assist mode which includes operation of a drive mechanism of the bicycle to power a drive train of the bicycle; or
a transmission mode which includes operation of the drive train in accordance with the mechanical gear for the bicycle or one or more second mechanical gears for the bicycle.

13. The bicycle of claim 9, comprising:
the input device configured to:
move about an axis to receive at least one second input of the plurality of inputs, the at least one second input to indicate a first adjustment to an audible output produced by a speaker of the bicycle; and
actuate to receive at least one third input of the plurality of inputs, the at least one third input to indicate a second adjustment to the audible output produced by the speaker.

14. (canceled)

15. The bicycle of claim 13, wherein the first adjustment or the second adjustment to the audible output produced by the speaker of the bicycle includes at least one of:
an adjustment to a decibel level for the audible output;
a pause of the audible output;
a continuation of the audible output;
an interrupt to the audible output; or
a selection of the audible output from a plurality of audible outputs.

16. The bicycle of claim 9, wherein the display assembly further includes:
a display device configured to:
present, via a graphical user interface, the one or more sets of information associated with the one or more aspects of the bicycle; and
receive, via the graphical user interface, one or more fourth inputs to adjust presentment of the one or more sets of information associated with the one or more aspects of the bicycle; and
a selector element configured to move about an axis to receive the one or more first inputs.

17. The bicycle of claim 9, comprising:
a series hybrid propulsion system configured to:
provide the amount of propulsion for the bicycle; or
operate in accordance with the mechanical gear for the bicycle.

18. An assembly, comprising:
a display assembly to couple with a handlebar of a bicycle, the display assembly configured to receive one or more first inputs to indicate a mode for the bicycle, wherein the display assembly includes:
a display device configured to:
present, via a graphical user interface, one or more sets of information associated with one or more aspects of the bicycle; and
receive, via the graphical user interface, one or more second inputs to adjust presentment of the one or more sets of information; and
a selector element configured to move about an axis to receive the one or more first inputs;
a control assembly to couple with a first handle of the handlebar, the control assembly configured to:
receive one or more third inputs to indicate one or more actions of the bicycle; and
an accessory assembly to couple with a second handle of the handlebar, the accessory assembly configured to receive one or more fourth inputs to cause at least one adjustment to the one or more actions of the bicycle.

19. The assembly of claim 18, wherein the one or more actions correspond to an amount of propulsion for the bicycle, and further comprising:
one or more processors, coupled with memory, in communication with the control assembly; and
the one or more processors configured to:
detect the one or more third inputs; and
provide, responsive to detection of the one or more third inputs, one or more signals, to a drive mechanism of the bicycle that is configured to power a drive train of the bicycle, to cause the drive train to provide the amount of propulsion for the bicycle.

20. The assembly of claim 18, wherein the mode for the bicycle corresponds to a drive train of the bicycle to operate in accordance with a mechanical gear for the bicycle, the one or more actions corresponding to the mechanical gear for the bicycle, and further comprising:
one or more processors, coupled with memory, in communication with the control assembly and the drive train; and
the one or more processors configured to:
detect the one or more third inputs; and
provide, responsive to detection of the one or more third inputs, one or more signals to cause the drive train to operate in accordance with the mechanical gear for the bicycle.

21. The system of claim 1, comprising:
the input device configured to actuate to receive at least one third input of the plurality of inputs, the at least one third input to cause the one or more second inputs to switch from an indication of the amount of propulsion to an indication of the mechanical gear.

22. The system of claim 1, comprising:
the input device configured to actuate to receive at least one third input of the plurality of inputs, the at least one third input to cause the one or more second inputs to switch from an indication of the mechanical gear to an indication of the amount of propulsion.
